(19) United States
(12) Patent Application Publication
(10) Pub. No.: US 2005/0227699 A1
(43) Pub. Date: Oct. 13, 2005

(54) Method and network element for optimisation of radio resource utilisation in radio access network

(76) Inventors: Harmen Schreuder, VALLEY PARK (SG); Theodore Buot, Spanish Village (SG)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/513,407

(22) PCT Filed: Jun. 26, 2002
(86) PCT No.: PCT/IB02/02456

§ 371 Date: Nov. 4, 2004

(51) Int. Cl. H04Q 7/20

(52) U.S. Cl. 455/453; 455/67.11

(57) ABSTRACT

The traffic loading in a CDMA or WCDMA system changes all the time and there can be large variations during the day or week. This means that the system sometimes operates near or at overload level. Thus, in the worst cases, there are periods of abnormal loadings from cell to cell, which is beyond any traffic forecast. On other occasions, some cells are slightly loaded. Therefore, the invention relates to a method and device for optimisation radio resource utilisation in a radio access network, wherein a trade-off between cell capacity and link quality is dynamically adjusted according to the actual cell load. In the case of high cell load connection quality of links within the cell is decreased and in case of low cell load connection quality of links within the cell is improved.

### FIELD OF THE INVENTION

The present invention relates to a method and device for optimisation of the radio resource utilisation in a data or communication network, such as a cellular radio access network (RAN), in particular CDMA (Code Division Multiple Access) or WCDMA (Wideband CDMA) networks.

### BACKGROUND OF THE INVENTION

The expression Radio Resource Utilisation (RRU) covers all functionality for handling air interface resources of a radio access network (RAN). These functions together are responsible for supplying optimum coverage, offering the maximum planned capacity, guaranteeing the required quality of service (QoS) and ensuring efficient use of physical and transport resources.

Accordingly, a Radio Resource Management (RRM) function consists of handover control (HC), power control (PC), congestion control, which is typically subdivided into admission control (AC), load control (LC), and packet data scheduling (PS), and a resource manager (RM).

The handover control (HC) takes care that a connected user is handed over from one network cell to another as he moves through the coverage area of a mobile network. The handover control of the UMTS (Universal Mobile Telecommunications System) Terrestrial Radio Access Network (UTRAN) supports different types of handovers and handover procedures.

In mobile communication systems such as third-generation systems, which are based on the CDMA or WCDMA techniques where all users can share a common frequency, interference control is a crucial issue. Therefore, the power control is responsible for adjusting the transmit powers in uplink (UL) and downlink (DL) to the minimum level required to ensure the demanded QoS.

For the UL direction, this is especially important since one mobile station (MS) located close to the base station (BS) and transmitting with excessive power can easily supersede mobiles that are at the cell edge, so called near-far effect, or even block the whole cell. In DL direction, the system capacity is directly determined by the required code power for each connection. Therefore, it is essential to keep the transmission powers at a minimum level while ensuring adequate signal quality at the receiving end.

The overall transmitted power assigned to a BS in the RAN is split among a pilot channel, a synchronisation channel, paging channels and traffic channels. The pilot signal strength is set to a fixed percentage of the maximum transmitted power. The strengths of the paging signal and the synchronisation signal are also constant. Then the remaining transmission power not reserved to the above mentioned control channels is available for traffic channels. A nominal transmission power level is defined for every traffic channel, wherein the effective transmission power can be arranged or controlled by means of a power control function, while not exceeding a given range.

In WCDMA a group of functions is introduced for this purpose. They are summarised as power control (PC) and consist of open-lop power control, inner-loop power control, which is also called fast closed-loop power control, outer-loop power control in both uplink and downlink, and slow power control applied to downlink common channels. Open-loop power control is responsible for setting the initial UL and DL transmission powers when a terminal device, e.g. a mobile station (MS) or a user equipment (UE) is accessing the RAN. The inner-loop power control estimates the received quality and adjusts the target signal to interference ratio (tSIR) for the fast close-loop power control so that the required quality is provided.

As already mentioned, in WCDMA it is required to keep the air interface load under a predetermined thresholds. The reasoning is that excessive loading prevents the network from guaranteeing the needed requirements. Then, e.g. the planned coverage area may not be provided, capacity is lower than required and/or the quality of service may be degraded. Moreover, an excessive air interface load can drive the RAN into unstable condition.

With respect to these issues, three different functions are used, all summarized under congestion control. The admission control (AC) handles all new incoming traffic. It checks whether a new packet switched or circuit switched radio access bearer (RAB) can be admitted to the system and produces the parameters for the newly admitted RABs. The use of AC schemes which constrain the BS to keep its operating point within a certain range of power is a necessary requirement in cellular RANs, such as UMTS or WCDMA networks. However, this reduces overall capacity of the RAN, while it does ensure that base stations never “crash” and that the network does not become unstable due to excessive interaction between cells. When traffic is too high, the RAN might become instable. In 3^{rd} generation cellular systems, an increase of non real time (NRT) data transmission is foreseen. Particularly, a great increase of Internet services is expected, which will have a main impact on DL transmissions.

The quality of a certain link can be measured by the E_{b}/Nₒ ratio, which is the level of the received bit energy to the interference density that a receiver equipment requires for proper decoding of the received signal. The RRM unit provided in the RNC needs to know the level of a reference E_{b}/Nₒ for optimal resource allocation. For instance, the DL reference E_{b}/Nₒ is needed in estimation of DL power chances with changing services and bit rates, scaling of maximum link power from that of the reference service, determination of initial downlink power, scaling of the power of the Downlink Shared Channel from that of the associated Dedicated Channel, and static matching. The DL reference E_{b}/Nₒ depends on the service (e.g. speech, circuit-switched data, packet-switched data), coding, bit rate, terminal speed, degree of multi-path diversity, and burstiness of the interference at the terminal device. Therefore, E_{b}/Nₒ tables each specific to a BS sector are stored at the RNC to indicate the reference E_{b}/Nₒ for each service and bit rate. The reference values stored in the E_{b}/Nₒ table are obtained from simulations e.g. from system supplier's link level simulations. In conventional systems, the reference values of the E_{b}/Nₒ table have been set during the network planning phase and maintained manually during network operation, or may be estimated based on real measurements of at least one predetermined control parameter, so as to update the reference table using the estimated reference control values.

The load control (LC) manages the situation when system load has exceeded the threshold(s) and some countermeasures have to be taken to get the system back to a feasible load. Packet data scheduling (PS) handles all non-real-time traffic, i.e. packet data users. Basically, it decides when a packet transmission is initiated and the bit rate to be used. Thus, the AC and LC, together with PS, ensure that the network stays within the planned condition.

As functional network elements, a resource manager (RM) is in charge of controlling the physical and logical radio resources under one radio network controller (RNC). The main tasks of the resource manager are to coordinate the usage of the available hardware resources and to manage the code tree.

Most of the RRM functionality is located in the RNC or a corresponding network control function. At least a part of the PC, the LC and the RM can also be found in the BS, while in UEs/MSs only the PC functionality is included.

However, the traffic loading in a CDMA and WCDMA mobile system changes all the time and there can be large variations during the day or week. This means that the system sometimes operates near or at overload level. Thus, in the worst cases, there are periods of abnormal loadings from cell to cell, which is beyond any traffic forecast. On the other hand, some cells may be scarcely loaded.

This abnormal loadings cause problems as dropping of calls due to bad quality or as loss of control of the network due to not meeting the demanded link quality targets, i.e. the network becomes unstable.

At the moment, a overload control is used to monitor the load condition of the network and as a counter measurement bearers that consumes more resources than the average for the bearer type are dropped. This results, as mentioned above, in case of increasing traffic load that the link qualities of the users will inevitably go down.

However, quality of service (QoS) does not mean that the user will receive the best possible quality all the time, it means that the application in use, e.g. voice call, video, browsing) receives service which is within the negotiated parameters and satisfies the user. A lot of effort has been made to design complete and effective QoS provision to guarantee the proper service for both real and non-real time services.

In a first glance, the easiest way to guarantee QoS would be to provide unlimited bandwidth for each connection, but obviously this is not practical. Thus, there will be always capacity limiting constraints. For example, the maximum load or capacity of a mobile system, as CDMA or WCDMA RANs, is defined in terms of the maximum allowed interference in the UL or the maximum allowed total base station power in the DL. These parameters are fixed by network dimensioning. Therefore a technique is needed to provide service to as much users for the given UL and DL allowed loadings that will consider the limiting network dimensioning parameters.

### SUMMARY OF THE INVENTION

Therefore, it is an object of the present invention to provide a method and device for managing more efficient the utilisation of the capacity of the radio interfaces of a radio access network.

Accordingly, this object is achieved by a method for optimisation radio resource utilisation in a radio access network, comprising the steps of detecting a load of the air interface in at least a part of said radio access network and adjusting dynamically connection quality of links based on the detected load.

Additionally, the above object is achieved by a network controlling device for optimising resource utilisation in a radio access network, comprising detecting means arranged for detecting a load of the air interface in at least a part of the radio access network and adjusting means arranged for dynamically adjusting a connection quality of links based on the detected load.

The system load can be defined in terms of the maximum allowed interference in the uplink (UL) or the maximum allowed total base station power in the downlink (DL). These parameters are fixed by network dimensioning. Therefore, the uplink connection quality of the air interface can be determined by a maximum allowed interference and the downlink connection quality of the air interface can be determined by a maximum allowed total transmit power.

This adjusting of the connection quality is dynamically performed by controlling a trade-off between capacity and link quality in the air interface. If the network is low loaded, the excess capacity is deemed to be useless if it cannot be utilised. At this condition, the best way to utilise such excess capacity is to improve the connection quality which can be done e.g. by increasing the individual link quality targets. (Note: In the DL, the increase in the quality would also require an increase in the maximum DL power per connection.) In the case of high load, the opposite can be done, meaning that the quality targets of individual links are decreased, resulting in a capacity increase at the expense of link quality. In some extreme cases, the maximum E_{b}/Nₒ targets need to be lowered first. For the packet bearers, the minimum cost to support a certain bit rate requires a higher frame error rate target (tFER). But nevertheless, a lower guaranteed bit rate is necessary to maintain a good connection for the circuit-switched bearers. The reduction or improvement of the quality targets can be different for different users or user groups.

Advantageously, this results in less call dropping and a more flexible system capacity. Further, users will have a lower quality link instead of a dropped call. User may experiences different link-quality at different times. However, congested periods are only a small percentage of the total operating hours.

Overall, the utilization of the capacity will be improved. Moreover, packet users will be encouraged to transmit more data if the perceived quality is good. From the network provider's point of view, excess capacity is exploited by more continuous utilisation of the system capacity by dynamical quality target settings.

The adjusting sets at least one link quality target. Such link quality target may be the frame error rate (FER) of a concerned individual bearer (this is accompanied by an increase in the maximum targets of the Outer loop's Eb/No). This FER of each bearer type for a base station can be derived of

$$FER = f ( \frac{{P}_{tx}}{{P}_{rx} Total} )$$

wherein Pₜₓ is the transmit power of said bearer and PᵣₓTotal is the total received power of said base station. The link quality target can also be a guaranteed bit rate for non-real time data. The adjusting is periodically performed according to a certain time interval.

Finally, the connection quality may be individually set for both downlink and uplink of the air interface. It may also be desired to set the connection quality individually for each link or a group of links.

Nevertheless, near overload the connection quality for the user is going down. However, the invention proposes a method to do this in an organised manner.

### BRIEF DESCRIPTION OF THE DRAWINGS

The above and other objects, features and advantages of the present invention will become clear from the following description of the preferred embodiments thereof, taken in conjunction with the accompanying drawings. It should be noted that through the figures same or equivalent parts are designated by the same reference number. Moreover, the invention will be described in greater detail by way of a preferred embodiment with reference to the accompanying drawings, in which

FIG. 1 shows diagrammatical illustration part of a radio access network structure according to the present invention; and

FIG. 2 shows a flow diagram of the method according to the present invention.

### DESCRIPTION OF THE PREFERRED EMBODIMENTS

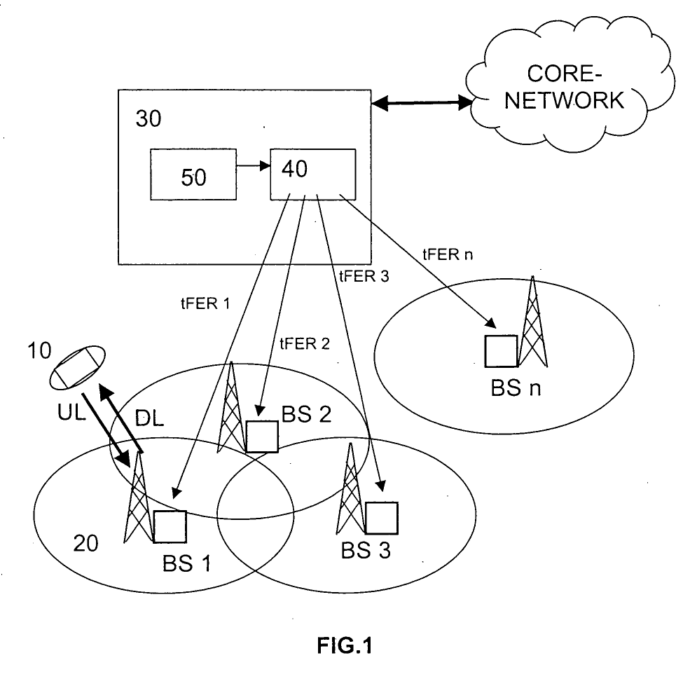

According to FIG. 1 it is shown a schematic block diagram of a transmission system according to a first preferred embodiment of the present invention, wherein a terminal device 10, e.g. a mobile terminal or a user equipment, is connected by a radio transmission link to a node B or base station 20. In the mobile terminal 10, a WCDMA transmitter is provided for generating a corresponding transmission signal to be supplied to a power amplifier in which the transmission power is adjusted based on a received power command, e.g. “up” or “down”, received via a return channel from the base station 20. The return channel comprises a radio network controller (RNC) 30 channel and a first-in-first-out (FIFO) register in which subsequent power control commands for different slots are successively stored. The return channel may be any feedback radio channel which can be established towards the mobile terminal 10 e.g. by the RNC 30 controlling the base station 20.

The base station 20 comprises a receiving filter for filtering the uplink signal transmitted by the mobile terminal 10 and supplying the filtered uplink signal to a WCDMA receiver, e.g. a Rake receiver comprising a collection of correlation receivers (fingers) in order to recover energy from several paths and/or antennas of a multi-path propagation. Furthermore, a comparator functionality is provided at the base station for comparing a control value derived from an FER value measured at the WCDMA receiver and a reference control value derived from an FER target value tFER supplied by an outer loop power control function provided at an RNC 30 serving the mobile terminal. The outer loop power control function is implemented by having the base station 20 tag each uplink user data frame with a frame reliability indicator, such as a Cyclic Redundancy Code (CRC) check result obtained at the WCDMA receiver during decoding of the particular user data frame. Should the frame reliability indicator indicate to the RNC 30 that the transmission quality is decreasing, the RNC 30 in turn will command the base station 20 to increase the target FER setpoint tFER by a certain amount. Based on the result of comparison, the comparator is arranged to output a transmitted power control command, e.g. “up” or “down”, supplied to the FIFO register of the return channel.

In the RNC 30, a memory is provided for storing a reference table comprising E_{b}/Nₒ reference control values which can be used e.g. as an initial FER Target value in uplink outer loop power control, for determining the NRT and RT load/power ratio used in admission control and packet scheduling, and for determining rate matching attributes. In the present case, the reference table is a two dimensional table, in which a bit rate BR and a target frame error rate (FER) tFER are used for addressing the reference table. Additionally, coding could provide a third dimension to the table. Furthermore, the RNC 30 comprises an target control unit 40 for continuously or regularly updating the reference table based on the FER targets tFER derived from the outer loop power control, i.e. the frame reliability measurements at the base station 20. The target control unit 40 may be an RRM functionality provided at the RNC. It is required that all adjacent cells in the RNC having the nearly the same connection quality targets. This is to avoid any problem of coordinating the soft handover (SHO) when each sector sets its own FER target independently.

The system load is constantly monitored by a load control 50 function at radio network controlling device. At the same time, based on that load control value the target control unit 40 within the radio network controlling device adjusts dynamically the appropriate connection quality targets tFER of each radio access bearer. Further, the quality targets of each bearer type are determined by the target control unit 40 via a function of the Ptx/PrxTotal ratio. As in the foregoing discussed, these settings are updated by a certain time interval by the target control unit 40. It should be noted that it may also be possible to control the update time interval with respect to statistical data of the cell load available. Thus, in high load periods the update may be performed more frequently, vice versa.

In a second preferred embodiment of the invention, not shown in the figures, available traffic profile data is used for using predetermined settings. For example, busy hours are well known for each cell or group of cells. Only in case of hotspots that can occur anytime in some areas without possibility of any forecast, the dynamically adjusting is activated.

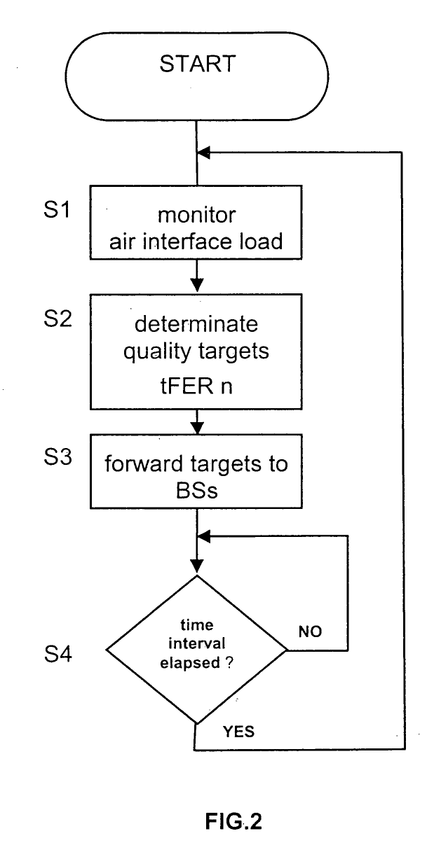

FIG. 2 is a flow diagram of the method from the present invention illustrating the dynamically adjusting of the trade-off between connection quality and system capacity within the RNC of FIG. 1. After system start, in step S1 the capacity utilisation of the network is monitored, wherein the system load is detected. The level of system load is forwarded to step S2, in which a appropriate target value for a quality target, e.g. FER, for the connection quality is determined. Here, an adequate function may be applied, as discussed herein above. In step S3 these target values are transmitted towards the base stations connected to the RNC. For reasons of network stability and also for avoiding wasting of system processing power, in step S3 a delay loop is incorporated that holds the adjusting process for a certain time interval. After the time interval has elapsed, the process goes back to step S1.

In the present invention a method and network element has been introduced for optimisation of the radio resource utilisation in a radio access network. In the first preferred embodiment of the invention, the system load is constantly monitored by a load control function at radio network controlling device. At the same time, a target control unit within the radio network controlling device adjusts dynamically the appropriate connection quality targets of each radio access bearer. Further, it has been introduced that the quality targets of each bearer type may be defined as a function of the Ptx/PrxTotal ratio. As a dynamically process, these settings are updated by a certain time interval by the target control unit. It may also be possible to control the update time interval with respect to statistical data of the cell load available. Thus, in high load periods the update may be performed more frequently, vice versa.

In the second preferred embodiment of the invention, available traffic profile data is used for using predetermined settings. For example, busy hours are well known for each cell or group of cells. Only in case of hotspots that can occur anytime in some areas without possibility of any forecast, the dynamically adjusting is activated.

It may be required for all adjacent cells controlled by the RNC to have nearly the same connection quality targets. This is to avoid any problem of coordinating the soft handover (SHO) when each sector sets its own FER target independently.

It is noted that the present invention is not restricted to the above preferred embodiments, but may be used for optimising radio resource utilization in any cellular radio access network. In particular, the resource control may be performed in any other network controlling device used for radio resource control function. Moreover, any parameter suitable for determining or setting a connection quality may be adjusted based on the detected load situation. The invention can be implemented in the Radio Access Controller (RNC) and/or the Base Station (BS), moreover, it can also be a functionality or a part of Radio Access Network (RAN), e.g. an UTRAN solution as well as an IP RAN.

1. A method for optimisation radio resource utilisation in a radio access network, comprising the steps of
a) detecting a load of the air interface in at least a part of said radio access network; and
b) adjusting dynamically connection quality of links based on the detected load.

2. A method according to claim 1, wherein the dynamical adjusting of the connection quality is performed by controlling a trade-off between capacity and link quality in the air interface.

3. A method according to claim 1, wherein during a higher load situation the connection quality of links is decreased, while during a lower load situation the connection quality of links is improved.

4. A method according to claim 1, wherein an uplink connection quality of the air interface is determined by a maximum allowed interference.

5. A method according to claim 1, wherein a downlink connection quality of the air interface is determined by a maximum allowed total transmit power.

6. A method according to claim 1, wherein said adjusting step is provided by setting at least one link quality target.

7. A method according to claim 6, wherein said link quality target comprises a frame error rate (FER) of a concerned individual bearer.

8. A method according to claim 7, wherein said frame error rate (FER) of each bearer type for a base station can be derived of
$$FER = f ( \frac{{P}_{tx}}{{P}_{rx} Total} )$$
wherein Pₜₓ is the transmit power of said bearer and PᵣₓTotal is the total received power of said base station.

9. A method according to claim 6, wherein said link quality target comprises a guaranteed bit rate for non-real time data.

10. A method according to claim 1, wherein said adjusting is periodically performed according to a certain time interval.

11. A method according to claim 1, wherein said connection quality is individually set for both downlink and uplink of the air interface.

12. A method according to claim 1, wherein said connection quality is individually set for each link or a group of links.

13. A network controlling device for optimising resource utilisation in a radio access network, comprising
a) detecting means arranged for detecting a load of the air interface in at least a part of the radio access network; and
b) adjusting means arranged for dynamically adjusting a connection quality of links based on the detected load.

14. A device according to claim 13, wherein said adjusting means is arranged to control a trade-off between capacity and link quality in an air interface of the radio access network.

15. A device according to claim 13, wherein said adjusting means is arranged to decrease the connection quality during high load and to improve the connection quality during low load.

16. A device according to claim 14, wherein a uplink connection quality of the air interface is given by a maximum allowed interference.

17. A method according to claim 13, wherein the downlink capacity of the air interface is given by a maximum allowed total transmit power.

18. A device according to claim 13, wherein said detecting means is arranged to derive a load level of said downlink from a level of transmit power.

19. A device according to claim 13, wherein said detecting means is arranged to derive a load level in the uplink from a level of interference.

20. A device according to claim 13, wherein said adjusting means is arranged to set at least one link quality target.

21. A device according to claim 20, wherein said quality target comprises a frame error rate (FER) of a concerned individual bearer.

22. A device according to claim 20, wherein said quality target is a guaranteed bit rate for non-real time data.

23. A device according to claim 13, wherein said adjusting means is arranged to control said connection quality for both downlink and uplink of the air interface individually.

24. A device according to claim 13, wherein said adjusting means is arranged to control said connection quality for each link or at least a group of links individually.

25. A device according to claim 13, wherein said device is a radio network controlling device.

26. A device according to claim 13, wherein said device comprises load control (LC) of a radio network controlling device.

27. A device according to claim 13, wherein said radio access network is a CDMA or WCDMA system.
